(19) United States
(12) Patent Application Publication
(10) Pub. No.: US 2026/0024352 A1
(43) Pub. Date: Jan. 22, 2026

(54) INFORMATION PROCESSING DEVICE, REAR IMAGE DISPLAY DEVICE, AND INFORMATION PROCESSING METHOD

(71) Applicant: Yazaki Corporation, Tokyo (JP)

(72) Inventors: Shinichi OKAMOTO, Susono-shi (JP); Aya HASHIMOTO, Susono-shi (JP); Koichiro ONO, Susono-shi (JP)

(73) Assignee: Yazaki Corporation, Tokyo (JP)

(21) Appl. No.: 19/259,283

(22) Filed: Jul. 3, 2025

(30) Foreign Application Priority Data
Jul. 18, 2024 (JP) 2024-114617

(51) Int. Cl. G06V 20/58; G06T 11/00; G06V 20/20; G06V 20/54

(52) U.S. Cl. CPC G06V 20/58; G06T 11/00; G06V 20/20; G06V 20/54; G06T 2210/62

(57) ABSTRACT

A solution is to detect whether a following vehicle detected in a rear image of a vehicle is exhibiting a road rage behavior, perform an image processing to the rear image of the vehicle if the following vehicle is exhibiting the road rage behavior; and display the processed image on a display device.

### TECHNICAL FIELD

The present invention relates to an information processing device, a rear image display device, and an information processing method.

### BACKGROUND ART

In a case of encountering a road rage behavior, it is possible for the driver to become stressed and make some driving mistakes. Thus, technologies for reducing the driving mistakes caused by the road rage behavior are being developed. For example, in Patent Document 1, a technology of changing the rear view by the rear-view mirror 2 so as not to show a following vehicle exhibiting the road rage behavior in the rear-view mirror 2.

### CITATION LIST

### Patent Documents

[Patent Document 1] JP 2010-271906A

### SUMMARY OF THE INVENTION

### Technical Problem

According to the technology disclosed in Patent Document 1, since the rear view by the rear-view mirror 2 has been changed such that the following vehicle exhibiting the road rage behavior is not shown in the rear-view mirror 2, it is impossible for the driver of the vehicle to confirm the circumstances near the following vehicle in the rear-view mirror 2.

A purpose of the present invention is to make it possible for the vehicle occupants to confirm the rear side of the vehicle without feeling any stress.

### Solution to Problem

In order to solve the above-identified technical problem, an information processing device according to an embodiment of the present invention includes a road rage detection portion configured to detect whether a following vehicle detected in a rear image of a vehicle is exhibiting a road rage behavior; an image processing portion configured to perform an image processing to the rear image of the vehicle if the following vehicle is exhibiting the road rage behavior; and a display processing portion configured to display the processed image by the image processing portion on a display device.

A rear image display device according to the embodiment of the present invention includes the information processing device and the display device.

An information processing method according to the embodiment of the present invention is an information processing method to be executed by a computer, including a road rage-behavior detection step to detect whether a following vehicle detected in a rear image of a vehicle is exhibiting a road rage behavior; an image processing step to perform an image processing to the rear image of the vehicle if the following vehicle is exhibiting the road rage behavior; and a display processing step to display the processed image by the image processing step on a display device.

### Effect of the Invention

According to the present invention, it is possible for the vehicle occupants to confirm the rear side of the vehicle without feeling any stress.

### BRIEF DESCRIPTION OF THE DRAWINGS

FIG. 1 is a view showing a rear image display device 100 according to an embodiment of the present invention.

FIG. 2 is a view showing a control portion 110.

FIG. 3 is a view showing an example of processing operations in the control portion 110.

### DESCRIPTION OF EMBODIMENTS

### <Rear Image Display Device 100>

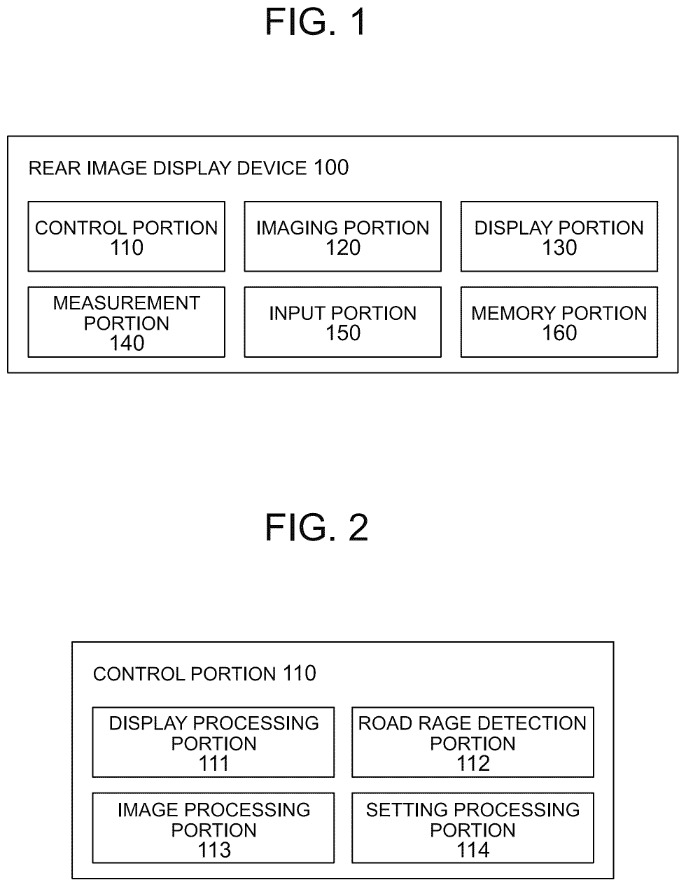

FIG. 1 is a view showing a rear image display device 100 according to an embodiment of the present invention. The rear image display device 100 is a device for prompting a rear image of the vehicle to an occupant of the vehicle (for example, a driver of the vehicle). The rear image display device 100, as shown in FIG. 1, includes a control portion 110, an imaging portion 120, and a display portion 130.

The control portion 110 is an information processing device for processing the information of computers or the like. The imaging portion 120 is an imaging device, such as a camera or the like, for imaging a rear image of a vehicle. The display portion 130 is a display device, such as a display or the like, for displaying the image, for example, the display (for example, a rear-view mirror monitor and a side mirror monitor) for an occupant of the vehicle (for example, a driver of the vehicle) to confirm the rear side of the vehicle.

FIG. 2 is a view showing the control portion 110. The control portion 110 includes a display processing portion 111. The display processing portion 111 displays the images captured by the imaging portion 120 on the display portion 130.

Therefore, according to the present embodiment, it is possible for the occupants of the vehicle to confirm the rear side of the vehicle by the image displayed in the display portion 130. As a result, according to the present embodiment, in particular, it is possible for the driver of the vehicle to confirm the rear side of the vehicle while driving the vehicle.

The control portion 110 according to the present embodiment further includes a road rage detection portion 112 and an image processing portion 113.

The road rage detection portion 112 detects, in an image captured by the imaging portion 120 (that is, a rear image of the vehicle), a vehicle travelling toward the present vehicle (the following vehicle) from the rear side of the present vehicle. The road rage detection portion 112 uses, for example, the image processing technology (for example, the existing image recognition processing technology) to detect the following vehicle in the images captured by the imaging portion 120.

Is it preferable for the rear image display device 100 to further include a measurement portion 140. The measurement portion 140 is a measurement device for detecting an object existing at the rear side of the vehicle using electromagnetic waves such as millimeter waves and infrared rays or the like, and sound waves such as ultrasonic waves or the like. Then, it is preferable to configure the road rage detection portion 112 to detect the following vehicle by using the measurement portion 140.

If the following vehicle is detected in the images captured by the imaging portion 120 (that is, the rear image of the vehicle), the road rage detection portion 112 then detects whether the following vehicle is exhibiting the road rage behavior. The road rage detection portion 112, for example, calculates an inter-vehicle distance therebetween with the following vehicle and/or a relative velocity with respect to the following vehicle, and then detects whether or not the following vehicle is exhibiting the road rage behavior according to the calculated inter-vehicle distance and/or the calculated relative velocity.

At this time, it is also preferable to configure the road rage detection portion 112 so as to detect whether or not the following vehicle is exhibiting the road rage behavior based on the images captured by the imaging portion 120 by using the image processing technology (for example, the existing image recognition technology), or it is also preferable to configure the road rage detection portion 112 so as to detect whether or not the following vehicle is exhibiting the road rage behavior based on the measurement by the measurement portion 140. That is, for the road rage detection portion 112, it is preferable to calculate the inter-vehicle distance therebetween with the following vehicle based on the images captured by the imaging portion 120 and/or the measurement by the measurement portion 140, or it is preferable to calculate the relative velocity with respect to the following vehicle based on the images captured by the imaging portion 120, the measurement by the measurement portion 140, and/or the velocity of the vehicle. Also, at this time, it is preferable to calculate the velocity of the vehicle based on the images captured by the imaging portion 120 and/or the measurement by the measurement portion 140, or it is preferable to obtain the information regarding the velocity of the vehicle from the vehicle itself.

The image processing portion 113, if the following vehicle is exhibiting the road rage behavior, performs image processing with respect to the images captured by the imaging portion 120. At this time, the image processing portion 113, as detailed below, performs processing with respect to the images captured by the imaging portion 120 so as to reduce the stress experienced by the vehicle occupants due to the following vehicle exhibiting the road rage behavior.

If the images captured by the imaging portion 120 are processed by the image processing portion 113, that is, if the following vehicle is exhibiting the road rage behavior, the display processing portion 111 displays the images processed by the image processing portion 113 on the display portion 130.

Therefore, according to the present embodiment, when the vehicle is suffering from the road rage behavior exhibited by the following vehicle, the processed images so as to reduce the stress experienced by the occupants of the vehicle due to the road rage behavior exhibited by the following vehicle are displayed on the display portion 130. Accordingly, in the present embodiment, it is possible to reduce the stress experienced by the occupants of the vehicle due to the road rage behavior exhibited by the following vehicle, and thus it is possible for the occupants of the vehicle to confirm the rear side of the vehicle without experiencing any stress.

### <Image Processing Due to Image Processing Portion 113>

It is preferable to configure the image processing portion 113 to rewrite, for example, an area relating to an area where the following vehicle is captured in the images captured by the imaging portion 120 (following-vehicle-related area) with another image when processing the images captured by the imaging portion 120. It is preferable that the image to be rewritten is, for example, is an image of a character. In this manner, it is possible to soften the impression that the vehicle occupants experience from the following-vehicle-related area, and thus it is possible to reduce the stress experienced by the occupants of the vehicle due to the road rage behavior exhibited by the following vehicle.

It is preferable for the image processing portion 113, when performing image processing with respect to the images captured by the imaging portion 120, for example, makes the following-vehicle-related area to be semi-transparent so as to make it difficult to confirm the following vehicle. In this manner, it becomes difficult for the occupants of the vehicle to visually confirm the following vehicle such that it is possible to reduce the stress experienced by the occupants of the vehicle due to the road rage behavior exhibited by the following vehicle.

The following-vehicle-related area, for example, may be the whole area in which the following vehicle is captured, or a part of the area in which the following vehicle is captured. In a case in which the following-vehicle-related area is part of the area in which the following vehicle is captured, this part of the area in which the following vehicle is captured may be an area in which the occupants of the following vehicle (for example, the driver of the following vehicle) is captured or an area in which a front window of the following vehicle is captured. In this manner, it becomes difficult for the occupants of the vehicle to visually confirm the facial expressions and behaviors of the occupants of the following vehicle so as to reduce the stress experienced by the occupants of the vehicle due to the road rage behavior exhibited by the following vehicle. At this time, it is preferable for the image processing portion 113 to, for example, use the image processing technology (for example, the existing image recognition technology) to detect the area in which the following vehicle is captured, the area in which the occupants of the following vehicle is captured, and the area in which the front window of the following vehicle is captured in the images captured by the imaging portion 120 (that is, the rear image of the vehicle).

It is preferable for the road rage detection portion 112, if the following vehicle is exhibiting the road rage behavior, to calculate a degree of the road rage behavior of the following vehicle based on the inter-vehicle distance and/or the relative velocity therebetween with the following vehicle. Then, it is preferable for the image processing portion 113 to change a way of the image processing in response to the calculated degree of this road rage behavior of the following vehicle.

For example, in a case of rewriting the following-vehicle-related area with other image (for example, the character image), it is preferable for the image processing portion 113 to change the variations of the other image for rewriting in response to the degree of road rage behavior exhibited by the following vehicle. For example, higher the degree of the road rage is, it is preferable to use the character image with a gentler impression. For example, if the degree of the road rage is middle, it is preferable to use a character image of a tiger as the character image for rewriting, and if the degree of the road rage is high, it is preferable to use a character image of a cat as the character image for rewriting.

For example, in a case of making the following-vehicle-related area to be semi-transparent, it is preferable to configure the image processing portion 113 to change a transmittance of the following-vehicle-related area in response to the degree of the road rage of the following vehicle. For example, it is preferable for the image processing portion 113 to make the transmittance of the following-vehicle-related area to be higher once the degree of the road rage behavior is higher. That is, it is preferable for the image processing portion 113 to make the following-vehicle-related area to be more transparent once the degree of the road rage behavior is higher so as to make it difficult to visually confirm the following-vehicle-related area.

### <Setting by User>

It is preferable for the rear image display device 100 to further include an input portion 150 and a memory portion 160. The input portion 150 is an input device for receiving the input of information, such as a touch panel, a keyboard, a button, a microphone or the like. The memory portion 160 is a storage device for storing information, such as a hard disk drive, a solid state drive, a memory or the like. Then, it is preferable for the control portion 110 to further include a setting processing portion 114.

The setting processing portion 114 obtains the setting information input by the user (for example, the occupant of the vehicle) via the input portion 150 and stores the input setting information in the memory portion 160.

It is preferable for the setting information, for example, to include the setting related to whether or not to perform the image processing when the road rage behavior is exhibited by the following vehicle. Then, if it is set, in the setting information stored in the memory portion 160, to perform the image processing when the road rage behavior is exhibited by the following vehicle, it is preferable for the road rage detection portion 112 to detect the road rage behavior (detection of the following vehicle), and if it is set, in the setting information stored in the memory portion 160, not to perform the image processing when the road rage behavior is exhibited by the following vehicle, it is possible for the road rage detection portion 112 to not to detect the road rage behavior.

Also, it is preferable for the setting information to include the setting relating which image processing to be performed (for example, a type of the image processing (rewriting the following-vehicle-related area with other images, or making the following-vehicle-related area to be semi-transparent), a type of the other image for rewriting, and a transmittance in a case of realizing the semi-transparent area). Then, it is preferable for the image processing portion 113 to perform the image processing based on the setting information. For example, in the setting information stored in the memory portion 160, if it is set to rewrite the following-vehicle-related area with other image, it is preferable for the image processing portion 113 to rewrite the following-vehicle-related area with other image, and in the setting information stored in the memory portion 160, if it is set to make the following-vehicle-related area to be semi-transparent, it is preferable for the image processing portion 113 to make the following-vehicle-related area to be semi-transparent. In this manner, it is possible to perform the image processing according to the user's preference.

### <Processing Operations in Control Portion 110>

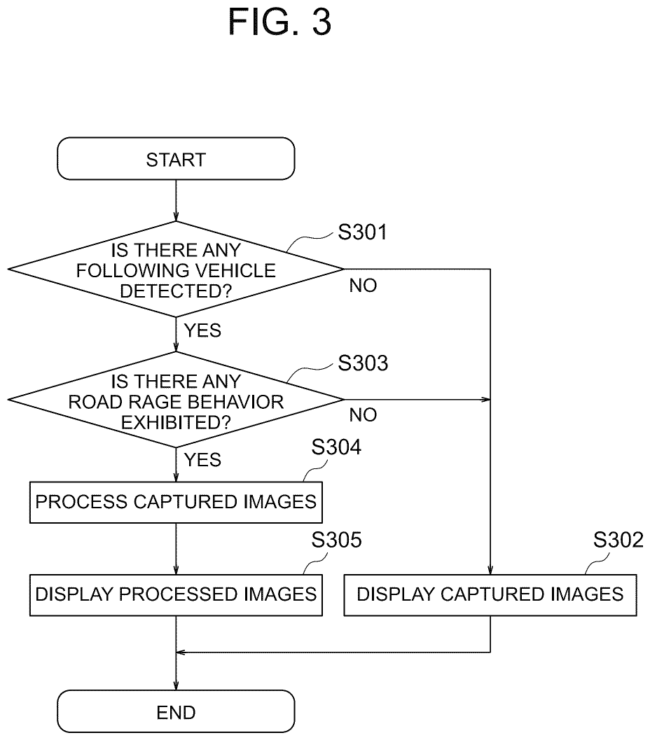

FIG. 3 is a view showing an example of processing operations in the control portion 110. The processing operations shown in FIG. 3 are, for example, performed every time when the image is captured by the imaging portion 120.

The following-vehicle-detection processing portion 112 detects the following vehicle in the image captured by the imaging portion 120 (Step S301).

If the following vehicle has not been detected (Step S301, NO), the display processing portion 111 displays the image captured by the imaging portion 120 on the display portion 130 (Step S302). If the following vehicle has been detected (Step S301, YES), the road rage detection portion 112 detects whether the following vehicle is exhibiting the road rage behavior (Step S303).

If the following vehicle is not exhibiting the road rage behavior (Step S303, NO), the display processing portion 111 displays the image captured by the imaging portion 120 on the display portion 130 (Step S302). If the following vehicle is exhibiting the road rage behavior (Step S303, YES), the image processing portion 113 performs the image processing with respect to the image captured by the imaging portion 120 (Step S304), and the display processing portion 111 displays this processed image on the display portion 130

### (Step S305).

It is noted that the above-described embodiment merely shows a typical aspect of the present invention, and the present invention is not limited to this embodiment. That is, various modifications can be made without departing from the scope of the invention. Of course, such modifications will fall within the scope of the present invention as long as they still have the configurations according to the present invention.

### REFERENCE SIGNS LIST

100 rear image display device
110 control portion
111 display processing portion
112 road rage detection portion
113 image processing portion
114 setting processing portion
120 imaging portion
130 display portion
140 measurement portion
150 input portion
160 memory portion

What is claimed is:

1. An information processing device, comprising:
a road rage detection portion configured to detect whether a following vehicle detected in a rear image of a vehicle is exhibiting a road rage behavior;
an image processing portion configured to perform an image processing to the rear image of the vehicle if the following vehicle is exhibiting the road rage behavior; and
a display processing portion configured to display the processed image by the image processing portion on a display device.

2. The information processing device according to claim 1, wherein the image processing portion is configured to rewrite a following-vehicle-related area as an area related to an area in the rear image of the vehicle where the following vehicle is shown with another image.

3. The information processing device according to claim 2,
wherein the road rage detection portion is configured to calculate a degree of the road rage behavior of the following vehicle, and
the image processing portion is configured to change a type of the other image to be rewritten in response to the degree of the road rage behavior.

4. The information processing device according to claim 1, wherein the image processing portion is configured to make a following-vehicle-related area as an area related to an area in the rear image of the vehicle where the following vehicle is shown to be semi-transparent.

5. The information processing device according to claim 2, wherein the following-vehicle-related area is whole of the area where the following vehicle is shown.

6. The information processing device according to claim 2, wherein the following-vehicle-related area is a part of the area where the following vehicle is shown.

7. The information processing device according to claim 6, wherein a part of the area where the following vehicle is shown is an area where any occupants of the following vehicle are shown or an area where a front window thereof is shown.

8. The information processing device according to claim 1, wherein the display device is a device for the occupant of the vehicle to confirm the rear side of the vehicle.

9. A rear image display device, comprising:
the information processing device according to claim 1, and
the display device.

10. An information processing method to be executed by a computer, comprising:
a road rage-behavior detection step to detect whether a following vehicle detected in a rear image of a vehicle is exhibiting a road rage behavior;
an image processing step to perform an image processing to the rear image of the vehicle if the following vehicle is exhibiting the road rage behavior; and
a display processing step to display the processed image by the image processing step on a display device.
